(19) United States
(12) Patent Application Publication
(10) Pub. No.: US 2024/0005823 A1
(43) Pub. Date: Jan. 4, 2024

(54) System For Advertising On Mobile Vehicles

(71) Applicant: William Carr, Phillipsburg, NJ (US)

(72) Inventor: William Carr, Phillipsburg, NJ (US)

(21) Appl. No.: 18/328,745

(22) Filed: Jun. 4, 2023

Related U.S. Application Data
(60) Provisional application No. 63/350,383, filed on Jun. 8, 2022.

(51) Int. Cl. G09F 19/18; G09F 21/04

(52) U.S. Cl. CPC G09F 19/18; G03B 21/145; G09F 21/04

(57) ABSTRACT

A projection system including: a projection device; an energy source; and means for sending images to the projection device, wherein the system is sized for use on the exterior of a mobile vehicle and projects onto at least on side of the vehicle.

This application claims priority to U.S. provisional patent application No. 63/350,383, filed Jun. 8, 2022.

### SUMMARY OF THE INVENTION

The present invention relates to a system for projecting advertising information on mobile vehicles.

### BACKGROUND OF THE INVENTION

Mobile vehicles such as cars, limousines and the like pick up and transport consumers to provide convenient transportation. There is sometimes a concern that the consumer may accidentally get into the wrong vehicle, putting themselves at risk. Cars have recently included lights that project an image from a bottom surface of their sideview mirrors onto the ground. The image may be the logo of the car manufacturer and the like. Published United States patent application 20190098268 teaches the use of projected images within the vehicle onto the windows for purposes, such as advertising. The images may be distracting for the driver, passengers, and or other drivers on the road. There is a need for an improved system for advertising on mobile vehicles.

### SUMMARY OF THE INVENTION

The present invention provides an advertising mobile projection system (1) that will safely and conveniently help vehicle operators become identifiable to consumers and/or passengers. The system includes a projection device (2); an energy source (3); and means for sending images to the projection device. (FIG. 1)

### BRIEF DESCRIPTION OF THE DRAWINGS

FIG. 1 is a front view of a device of the present invention attached to a side view mirror of a vehicle.

FIG. 2 is an exploded view of the device of FIG. 1 showing the components.

FIG. 3 is a front view to show means of adjusting the device of FIG. 1.

FIG. 4 is a front view to show an adjustable feature between the housing and projection device.

FIG. 5 is a side view of a vehicle to show where projection would appear on the door panel of vehicle.

### DETAILED DESCRIPTION OF PREFERRED EMBODIMENTS

The projection device (2) utilized in the present invention may be a mini commercially sourced projection system contained within a hermetically sealed housing (5). An example of a suitable projector is KODAK RODPJS75. The projection system (1) may be permanently installed on sideview mirrors or may be removeable with the ability to re-attach. The method of attachment (8) the projector may be provided through the use of adhesives, snap fits, suction cups, magnets and the like.

The projection system (1) includes a projection device (2), a housing (5), a mirrored lens (4), a energy source (3), and a printed circuit board (6). The printed circuit board may be attached to the projection device with a conducting wire (9). Housing (5) has a back plate (11). The back plate can either be integral into housing (5) or may be formed separately and attached by means known in the art. Housing (5) may be directly attached to projection device (2) or may be adjustably attached to the device with extender (10). The extender (10) has elements that snap in to place to control how far the projection device (2) extends. The projection system (1) is powered through an energy source (3). The energy source (3) may be a hard wire (such as the wiring used to power electric windows and the like), battery power (such as watch batteries and the like), or solar powered. Hard wiring the projection system (1) into the side view mirrors, pig tailing off power allotted to the mirrors, will optimize running time while utilizing the car battery. Minimal power draw of 100 mA and a self-sustaining energy source (3), will allow continuous use regardless of running time. The projection system (1) may also use both a primary and a secondary power option, for example hard wiring and a backup battery option, a secondary source of power requiring no arduous setup. The battery may be commercially sourced, and the device may have a direct current input located on the outside for rechargeability.

An image is sent to the projector system (1) for transmission onto the sides of the vehicle. Images may be stored on a chip (7) within the projection device. Alternatively, through Bluetooth technologies, smart phones may be used to connect across a wireless network, powering the device on/off while mirroring images. These images may display on the driver/passenger side doors, offering certain advertisements and/or services (for example, but not limited to, the name of a restaurant, driving service such as UBER® and the like) (FIG. 5). Projecting images on the door panel will not interfere with an adjacent vehicle or driver's vision. The necessary distance to display images on the vehicle will be achieved through connecting the projection device to rear side view mirrors.

The projection system (1) will project the desired image via light onto the sides of the vehicle. Focusing will enable the image to remain sharp and not distorted along the length of the vehicle. In an embodiment, and operator connects her smart phone to projector. Once a stable connection has been achieved, multiple focusing dials (which will be included on the device) will be adjusted. Software associated with the device will allow for image distortion, this is necessary due to door panel geometry varying in size, shape & form. Each operator of a vehicle will need to make these adjustments based on device placement.

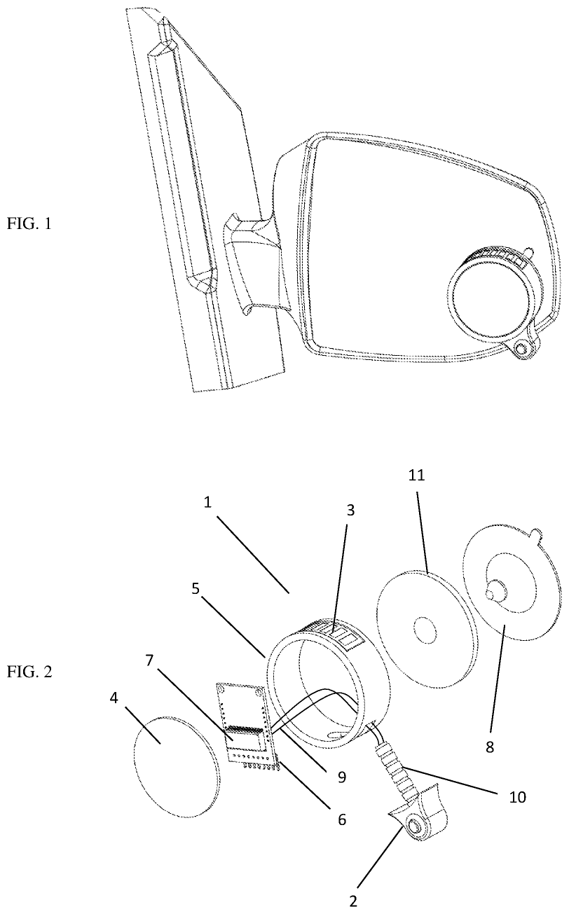

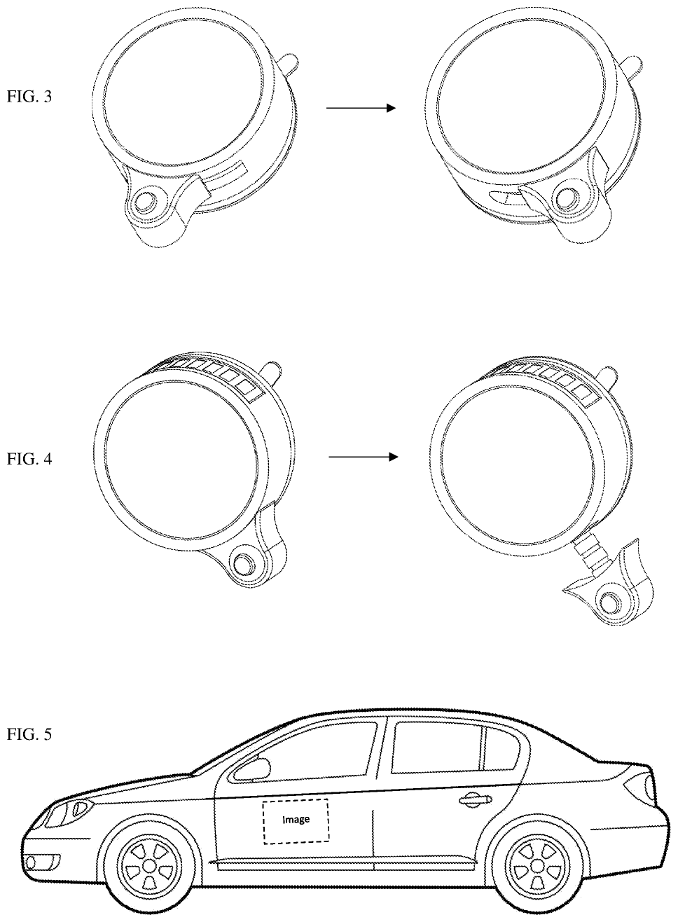

Once attached to the vehicle, the projection system (1) may nest within the framework of the side view mirror (FIG. 1). Alternatively, the projection system may be mounted outside of the framework. To achieve discretion, the face of the device will have a rotational mirrored lens (4), doubling as blind spot mirror for additional vehicle protection. A projection lens located at the bottom of the device will be both rotational (FIG. 3) and extendable (FIG. 4) for enhanced image quality. By rotating the projection device (2), images will move both horizontally and vertically along the projected area of vehicle. When extending the projection device (2), the image on the projected surface will be enhanced dimensionally. The approximated size of the projection system (1) 50 mm dia.×18 mm depth will be non-invasive on line of sight when viewing the mirror. With this digital advertisement device, vehicle operators can display a multitude of images at any given time. Currently, drivers display static images on personal vehicles for ride sharing & food delivery companies. This small compact mobile projection device will eliminate this method of advertising and personalize every delivery or pickup.

The present invention also provides a method for displaying the identity of a service provider including installing the projection system of the present invention on a vehicle and projecting the identity of the service provider on the side of the vehicle.

I claim:

1. A projection system comprising:
a projection device;
an energy source; and
means for sending images to the projection device, wherein the system is sized for use on the exterior of a mobile vehicle and projects onto at least on side of the vehicle.

2. The projection system of claim 1 wherein the projection device is attached to at least one side view mirror of the vehicle.

3. The projection system according to claim 2 wherein the projection device is attached to the side view mirror by a removeable and re-attachable suction cup.

4. The projection system according to claim 2 wherein the projection device is attached to the side view mirror by a magnet.

5. The projection system according to claim 1 wherein the projection device is powered by hard wiring to a mobile vehicle electric system.

6. The projection system according to claim 1 wherein the projection device is powered by at least one battery.

7. The projection system according to claim 1 wherein the image is adjustable via focusing dials.

8. The projection system according to claim 1 wherein the system is controlled via smart phone and Bluetooth technologies.

9. The projection system according to claim 1 wherein the system uses Software for composing messaging.

10. The projection system according to claim 1 wherein the system uses Software to permit the operator to alter message/graphic.

11. The projection system according to claim 1 wherein the system uses Software to distort message/graphic based on placement of projector and geometry of surface projected on.

12. The projection system according to claim 1 wherein the projection device is powered by a self-sustaining energy source.
